(19) United States
(12) Patent Application Publication
(10) Pub. No.: US 2019/0304309 A1
(43) Pub. Date: Oct. 3, 2019

(54) DRIVING ASSISTANCE DEVICE

(71) Applicant: DENSO CORPORATION, Kariya-city (JP)

(72) Inventors: Keiya SAKAMOTO, Kariya-city (JP); Ichiro YOSHIDA, Kariya-city (JP)

(21) Appl. No.: 16/442,589

(22) Filed: Jun. 17, 2019

Related U.S. Application Data
(63) Continuation of application No. PCT/JP2017/038157, filed on Oct. 23, 2017.

(30) Foreign Application Priority Data
Dec. 19, 2016 (JP) 2016-245490

(51) Int. Cl. G08G 1/16; B60W 10/18; B60W 10/20; B60W 30/095; B60W 30/16

(52) U.S. Cl. CPC G08G 1/163; B60W 10/18; B60K 2031/0025; B60W 30/0956; B60W 30/16; B60W 10/20

(57) ABSTRACT

A driving assistance device acquires data on a traveling situation, a travel speed, an inter-vehicle distance, an acceleration control, a braking control, and a steering control related to a nearby vehicle having a communication function. The driving assistance device detects a nearby vehicle having no communication function. The driving assistance device detects a traveling situation of the nearby vehicle having no communication function. The driving assistance device predicts a traveling state of the nearby vehicle having the communication function based on traveling situation data acquired by the vehicle data acquisition unit, and predicts a traveling state of the nearby vehicle having no communication function based on traveling situation data acquired by the traveling situation detector.

### CROSS REFERENCE TO RELATED APPLICATIONS

The present application is a continuation application of International Patent Application No. PCT/JP2017/038157 filed on Oct. 23, 2017, which designated the United States and claims the benefit of priority from Japanese Patent Application No. 2016-245490 filed on Dec. 19, 2016. The entire disclosures of all of the above applications are incorporated herein by reference.

### TECHNICAL FIELD

The present disclosure relates to a driving assistance device having a function to automatically operate a vehicle.

### BACKGROUND

In a situation where an automatically operated vehicle and a manually operated vehicle are running on the same road, the automatically operated vehicle requires to completely predict behaviors of the manually operated vehicle in order to safely perform automatic operation control. For safe driving, a driver of a manually operated vehicle requires to know whether nearby vehicles are operated automatically or manually.

### SUMMARY

A driving assistance device may acquire data on a traveling situation, a travel speed, an inter-vehicle distance, an acceleration control, a braking control, and a steering control related to a nearby vehicle having a communication function. The driving assistance device may detect a nearby vehicle having no communication function. The driving assistance device may detect a traveling situation of the nearby vehicle having no communication function. The driving assistance device may predict a traveling state of the nearby vehicle having the communication function based on traveling situation data acquired by the vehicle data acquisition unit, and predict a traveling state of the nearby vehicle having no communication function based on traveling situation data acquired by the traveling situation detector.

### BRIEF DESCRIPTION OF DRAWINGS

The above and other objects, features and advantages of the present invention will become more apparent from the following detailed description made with reference to the accompanying drawings. In the drawings:

FIG. 1 is a block diagram illustrating a driving assistance device for vehicles according to a first embodiment;

FIG. 2 is a flowchart illustrating main control of a controller (part 1);

FIG. 3 is a flowchart illustrating main control of the controller (part 2);

FIG. 4 is a flowchart illustrating control over acquisition of environmental information about nearby traveling;

FIG. 5 is a flowchart illustrating control over operation mode changeover notification;

FIG. 6 is a diagram illustrating a display of guidance notification concerning the operation mode changeover;

FIG. 7 is a diagram illustrating a display during the operation mode changeover;

FIG. 8 is a diagram illustrating a display of emergency guidance;

FIG. 9 is a diagram illustrating positional relationship between a subject vehicle and a different vehicle (part 1);

FIG. 10 is a diagram illustrating acquisition of information about vehicle states;

FIG. 11 is a diagram illustrating positional relationship between a subject vehicle and a different vehicle (part 2);

FIG. 12 is a diagram illustrating determination control examples when a subject vehicle travels a cruising lane of an expressway;

FIG. 13 is a diagram illustrating positional relationship between a subject vehicle and a different vehicle (part 3);

FIG. 14 is a diagram illustrating determination control when a subject vehicle is traveling a passing lane of an expressway;

FIG. 15 is a diagram illustrating positional relationship between a subject vehicle and a different vehicle (part 4);

FIG. 16 is a diagram illustrating determination control concerning different vehicles frequently changing lanes when a subject vehicle decelerates to approach a congested area;

FIG. 17 is a diagram illustrating determination control concerning different vehicles less frequently changing lanes when a subject vehicle decelerates to approach a congested area;

FIG. 18 illustrates positional relationship between a subject vehicle and a different vehicle (part 5);

FIG. 19 is a diagram illustrating determination control concerning a subject vehicle decelerating in a traffic congestion; and

FIG. 20 is a diagram illustrating definition of automation levels of the automatic operation.

### DETAILED DESCRIPTION

For example, a device having a function to predict courses for nearby vehicles has been proposed. For example, a device that allows a display apparatus to display a specified vehicle out of vehicles targeted at the cooperative driving, namely, an adaptive cruise control has been proposed. For example, a device that prompts a driver to disable automatic operation when it is determined that a condition to enable the automatic operation is not satisfied has been proposed.

For example, an apparatus that detects a manually operated vehicle based on the inter-vehicle communication and capable of providing advantages of the automatic operation and the manual operation when automatically operated vehicles and manually operated vehicles are running in the same road has been proposed. For example, an apparatus that captures images of a vehicle running around, determines an operation system of the vehicle running around based on captured images, and appropriately settles conditions of capturing the vehicle based on a determination result has been proposed.

In an example embodiment of the present disclosure, a driving assistance device includes a vehicle data acquisition unit, a detector, a traveling situation detector, and a traveling prediction unit. The vehicle data acquisition unit acquires data on a traveling situation, a travel speed, an inter-vehicle distance, an acceleration control, a braking control, and a steering control related to a nearby vehicle having a communication function. The detector detects a nearby vehicle having no communication function. The traveling situation detector detects a traveling situation of the nearby vehicle having no communication function. The traveling prediction unit predicts a traveling state of the nearby vehicle having the communication function based on traveling situation data acquired by the vehicle data acquisition unit, and predicts a traveling state of the nearby vehicle having no communication function based on traveling situation data acquired by the traveling situation detector. The traveling prediction unit includes a notification unit that notifies a prediction result to a user. The traveling prediction unit advises the user to change a driving mode when the traveling prediction unit determines that prediction accuracy of the prediction result is insufficient. The driving assistance device further includes a ready determination unit configured to determine whether the user is ready for changing to a manual operation when changing of the driving mode from an automatic operation to the manual operation is approved by the user.

In another example embodiment of the present disclosure, a driving assistance device includes a vehicle data acquisition unit, a detector, a traveling situation detector, a traveling prediction unit, a user information acquisition unit, an ability detector, and an ability-to-deal-with-driving determination unit. The vehicle data acquisition unit configured to acquire data on a traveling situation, a travel speed, an inter-vehicle distance, an acceleration control, a braking control, and a steering control related to a nearby vehicle having a communication function. The detector detects a nearby vehicle having no communication function. The traveling situation detector detects a traveling situation of the nearby vehicle having no communication function. The traveling prediction unit predicts a traveling state of the nearby vehicle having the communication function based on traveling situation data acquired by the vehicle data acquisition unit, and predicts a traveling state of the nearby vehicle having no communication function based on traveling situation data acquired by the traveling situation detector. The user information acquisition unit acquires physical information of the driver. The ability detector detects an ability of the driver to perform a manual operation of a subject vehicle based on the physical information of the driver. The ability-to-deal-with-driving determination unit determines, based on the detected ability of the driver, whether the ability of the driver to perform the manual operation of the subject vehicle is sufficient to deal with the traveling state of the nearby vehicle predicted by the traveling prediction unit when a change to the manual operation is selected by the driver.

The example embodiments of the present disclosure can accurately determine whether a vehicle having no communication function, such as an inter-vehicle communication function is operated automatically or manually.

### First Embodiment

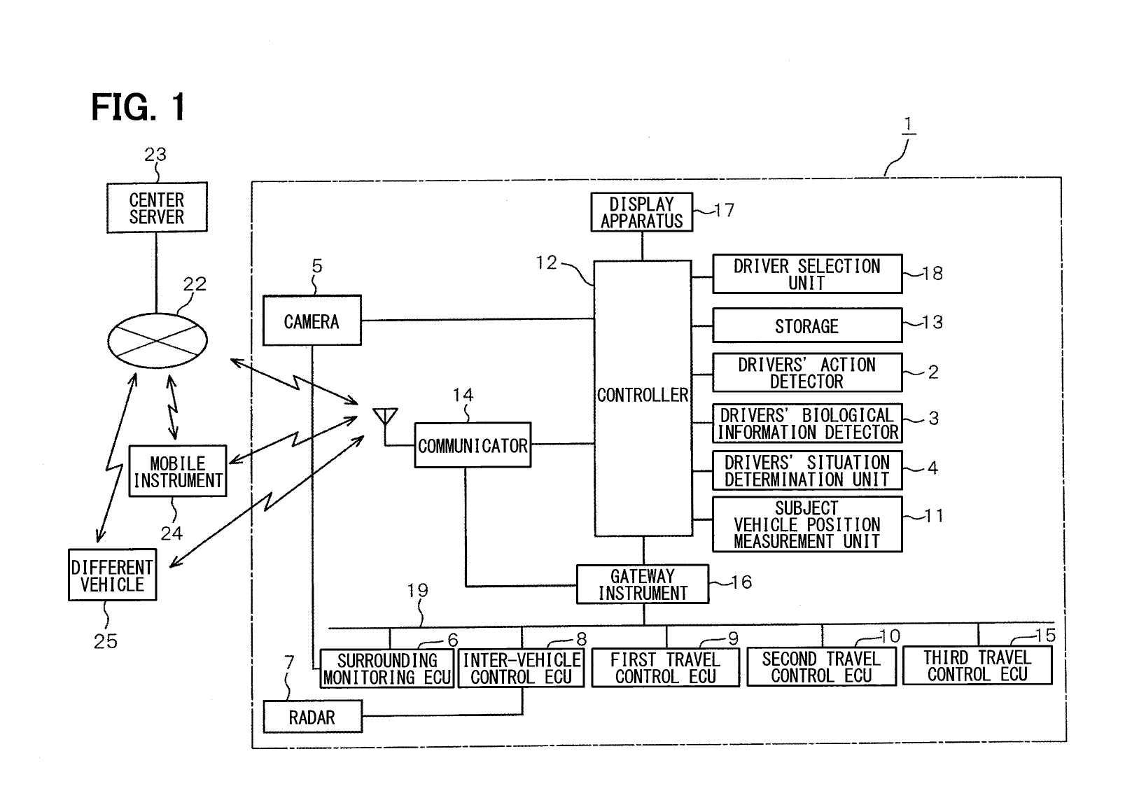

The description below explains the first embodiment with reference to FIGS. 1 through 20. As illustrated in FIG. 1, a driving assistance device 1 for vehicles includes a drivers' action detector 2, a drivers' biological information detector 3, a drivers' situation determination unit 4, a camera 5, a surrounding monitoring ECU (electronic control unit) 6, a radar 7, an adaptive cruise control ECU 8, a first travel control ECU 9, a second travel control ECU 10, a third travel control ECU 15, a subject vehicle position measurement unit 11, a controller 12, a storage 13, a communicator 14, a gateway instrument 16, a display apparatus 17, and a driver selection unit 18.

The drivers' action detector 2 detects driving operation of a driver and outputs a detection signal. Specifically, the drivers' action detector 2 detects a speed or the accuracy of the driving operation of a driver such as operating the accelerator, the brake, or the steering wheel based on a sensor signal from an angle sensor attached to an accelerator, a brake, or a steering wheel (not shown).

The drivers' biological information detector 3 detects biological information about a driver and outputs a detection signal. Specifically, the drivers' biological information detector 3 detects conscious or emotional situations of a user (such as a driver or a passenger) by using various sensors (not shown) to measure an electrocardiogram, heart rates, blood pressures, or perspiration, or a brain sensor (not shown) to measure distribution of active regions in the brain. The various sensors and the brain sensor for the drivers' biological information detector 3 are favorably available as wearable sensors attachable to clothes or hair accessories in order to acquire biological information about the driver or the passenger.

Detection information detected by the drivers' action detector 2 and the drivers' biological information detector 3 is input to the drivers' situation determination unit 4 that determines a driver (user) situation. The drivers' situation determination unit 4 determines a physical situation of the driver during driving and a psychological state of the driver or the passenger based on the input information. The determined information is output to the controller 12. The physical situation during driving signifies a muscular response of limbs or visual perception (such as visual field or dynamic visual acuity) toward the outside of the vehicle. The psychological state signifies a mental (psychological) state estimated based on measured information such as heart rates, blood pressures, or brain waves.

The camera 5 includes a plurality of cameras to capture situations outside the vehicle. The captured image information is output to the surrounding monitoring ECU 6 and the controller 12. The surrounding monitoring ECU 6 recognizes a situation around the vehicle (such as what kind of object at which position) based on the image information captured by the camera 5 and outputs the recognized surrounding monitoring information to the controller 12 via an onboard LAN 19.

The radar 7 includes a function that uses a microwave or a laser to detect the distance and the direction to an object (an object around the vehicle) such as a vehicle or a pedestrian around the subject vehicle. The detected object detection information is output to the adaptive cruise control ECU 8. The adaptive cruise control ECU 8 is supplied with the object detection information around the vehicle and, based on this object detection information, controls vehicle traveling (such as braking and acceleration) so as not to collide with objects around the vehicle.

The first travel control ECU 9 is supplied with the object detection information around the vehicle via the onboard LAN 19 and, based on this object detection information around the vehicle, controls traveling (braking and acceleration) in the front-back direction of the vehicle. The second travel control ECU 10 is supplied with the object detection information around the vehicle via the onboard LAN 19 and, based on this object detection information around the vehicle, controls traveling (such as steering manipulation, braking, and acceleration) in the horizontal direction of the vehicle. The third travel control ECU 15 is supplied with the object detection information around the vehicle via the onboard LAN 19 and, based on this object detection information around the vehicle, controls traveling (such as control over speeds or attenuation of a variable damper, braking, and acceleration) in the vertical direction of the vehicle.

The subject vehicle position measurement unit 11 measures the position of the subject vehicle as latitude/longitude information by using a GPS (not shown) and outputs vehicle position measurement information to the controller 12. The controller 12 controls automatic traveling of the vehicle based on the vehicle position measurement information or the object detection information around the vehicle. The controller 12 provides an instrument for master control. The controller 12 provides functions as a vehicle data acquisition unit, a detector, a traveling situation detector, a traveling prediction unit, a user information acquisition unit, an ability detector, an ability-to-deal-with-driving determination unit, a manual changeover restrictor, an automatic operation determination unit, an automatic changeover restrictor, and a ready determination unit.

The ECUs (the adaptive cruise control ECU 8, the first travel control ECU 9, the second travel control ECU 10, the third travel control ECU 15, and the controller 12) may interchange respective ECU information or measurement information with each other via the onboard LAN 19. Autonomous operation of each ECU may coordinately control automatic traveling of the vehicle (referred to as coordinate control). When the coordinate control is performed, the onboard LAN 19 is favorably configured as a high-speed onboard network in order to fast interchange information for the traveling control among the ECUs. The high-speed onboard network favorably uses optical fiber capable of multi-channel communication that ensures a high communication speed and can simultaneously transmit data of a plurality of the ECUs to the other ECUs. The communication may be configured to allow a data header to include data representing the urgency of information output from each ECU. This can provide a safer vehicle traveling control.

Using the communicator 14, the controller 12 is capable of communicating with a center server 23 via a wireless communication network (such as a cellular phone communication network or the Internet) 22. Moreover, the controller 12 is capable of communicating with a mobile instrument 24 such as a smartphone (external instrument) carried by a pedestrian via the communicator 14. In this case, communication with the mobile instrument 24 uses a wireless LAN or the wireless communication network 22, for example. The mobile instrument 24 is capable of communicating with the center server 23 via the wireless communication network 22.

Furthermore, the controller 12 is capable of communicating with a different vehicle 25 via the communicator 14. In this case, communication with the different vehicle 25 is compliant with an inter-vehicle communication standard (such as V2X communication standard). The different vehicle 25 is favorably capable of communicating with the center server 23 via the wireless communication network 22.

The present embodiment communicates with the different vehicle 25 or the mobile instrument 24 carried by a pedestrian and thereby acknowledges a position of the different vehicle 25 or a position of the pedestrian carrying the mobile instrument 24. The automatic operation for safe driving is available based on the acknowledged information.

The present embodiment acknowledges information such as movement situations or control situations concerning the different vehicle 25 or movement information about a pedestrian acquired by the communication and thereby evaluates the difficulty of automatic operation under a travel environment at that time. A vehicle in the process of the automatic operation is stopped or the automatic operation is changed to the manual operation under the travel environment inappropriate for the automatic operation. The present embodiment evaluates the difficulty of automatic operation control and advises a driver to change the automatic operation to the manual operation when the manual operation is supposed to reduce uneasiness from a user. This control will be described in detail later.

According to the present embodiment, the controller 12 may determine a road environment such that the camera or the radar can hardly measure or cannot acknowledge a road situation to be traveled by the subject vehicle. For example, the road situation is so determined that the road shape varies considerably and obstructive trees hide the road shape ahead or buildings hinder the perspective ahead. In such a case, the following process is performed. In such a situation, the controller 12 performs preliminary determination based on the camera image information and road shape data recorded in the storage 13.

The preliminary determination signifies a process in which the controller 12 predicts what exists at a position unseen from the camera 5 (namely, a driver) based on the information such as a map database or a road shape database recorded in the storage 13 and determines what control (such as deceleration or steering) is needed for safe traveling. The controller 12 performs this preliminary determination to transmit necessary information to each ECU. The preparation available for the automatic operation to ensure the safety of the driver is referred to as a preventive automatic operation.

According to the present embodiment, the drivers' biological information detector 3, the drivers' action detector 2, and the subject vehicle position measurement unit 11 measure what reaction the driver shows depending on places or traveling states (automatic operation and manual operation) of the vehicle. The storage 13 records the measurement result as “drivers' characteristics data.” The center server 23 periodically records data representing actions or reactions characteristic of the driver via the communicator 14 and the wireless communication network 22. Therefore, data stored in the center server 23 can be used to easily recover data that is recorded in the storage 13 of the vehicle even when the data is possibly lost due to a traffic accident.

Road shape data stored in the storage 13 stores automatic operation categories as road characteristics such as an automatic-operation-dedicated road, an automatic-operation-prioritized road (allowing a mixture of manual operation and automatic operation), a manual-operation-dedicated road, and a road allowing the automatic operation only to a vehicle given the automatic operation accuracy (namely, performance) higher than or equal to a predetermined value. The controller 12 allows the display apparatus 17 to display the above-described automatic operation categories of roads around the subject vehicle along with a map.

According to the present embodiment, the controller 12 may determine that the automatic operation needs to be changed to the manual operation while the vehicle is traveling a road specified by using a car navigation function. In such a case, a driver is notified that the manual operation is needed by using a notification unit of the vehicle capable of providing notification methods such as the display apparatus 17, a room lamp, a meter panel, sound, a voice output apparatus, and an apparatus applying vibration to the driver's seat.

The driver may not respond to the above-described notification. In such a case, the present embodiment alerts the driver by providing the driver with stimulation to activate the consciousness (brain) of the driver. The stimulation includes voice, vibration, and a weak current generated by a steering system or a wearable instrument. The drivers' situation determination unit 4 may determine whether the notification to the driver is successful in order to continue the notification until the driver is definitely alerted.

In anticipation of changing the driver, the present embodiment includes the driver selection unit 18 to perform processes of recognizing the ID of an electronic key or a mobile instrument carried by the driver and recognizing the driver based on camera images. In this case, the driver can be highly safely recognized by using a database registered to the center server 23 to perform a recognition process or an identification process of the driver.

The driver (or a passenger) may feel uneasy when the driving assistance device 1 of the vehicle automatically changes the traveling control. To solve this, the present embodiment daily acquires a relationship between the traveling condition and the emotional level of uneasiness felt by the driver or the passenger and allows the storage 13 to store vehicle movement situations that easily make the driver and the others uneasy. It is advantageous to store the strong relationship between a traveling position and a place to cause uneasiness, for example. The present embodiment provides a notification corresponding to user characteristics (such as personality and athletic ability) to ensure the safety of users when the driving mode is changed between the automatic operation and the manual operation.

The driving assistance device 1 may recognize that the driver prefers platooning among automatically operated vehicles. In this case, the present embodiment advises the driver to change to the manual operation when platoons are likely to collapse. When the vehicle under the automatic operation control is surrounded by an increasing number of manually operated vehicles or manual operations of vehicles ahead and behind are supposed to be unstable, the present embodiment appropriately advises changing the automatic operation to the manual operation and moving to a place under the favorable travel environment. The notification is favorably adjustable for each driver so that the driver (or the user) can easily accept the notification timing, the notification sound volume, and the display visibility.

According to the present embodiment, the controller 12 can communicate with the mobile instrument 24 such as a smartphone (external instrument) via the communicator 14. The mobile instrument 24 can remotely control the vehicle. It is favorable to provide a method of installing a remote control application on the mobile instrument 24 in order to remotely control the vehicle. From the viewpoint of security, an additional remote controller may be provided to enable a remote control operation only in response to input of specific information (such as biological information or a brain wave pattern of the user).

When the mobile instrument 24 is available near the vehicle, the communicator 14 can be provided as a communication instrument compatible with communication systems such as NFC (Near Field Communication) and DSRC (Dedicated Short Range Communication). When the mobile instrument 24 is distant from the vehicle, it is possible to use a mobile instrument compatible with the communication using the wireless communication network 22 (such as a cellular phone communication network).

The controller 12 allows the communicator 14 to be capable of receiving information that is needed for the vehicle and is transmitted from the center server 23 of an information center. In this case, the communicator 14 favorably uses an instrument compatible with wireless communication using the cellular phone communication network or a wireless instrument called a Wi-Fi communication instrument compatible with the communication using the Internet via a wireless LAN. Communication data processed by the communicator 14 of the vehicle is transmitted to the gateway instrument 16 mounted on the vehicle. The gateway instrument 16 checks the received data and, if normal, transmits the received data to the various types of ECUs via the onboard LAN 19. The gateway instrument 16 includes a “remote control data determination function (authentication function).” When the gateway instrument 16 receives the remote control data transmitted from the external mobile instrument 24 and a request to change the traveling situation of the vehicle, the remote control data determination function determines whether the remote control data is valid and a control result is appropriate (causing no accident or causing no harm to the user).

The controller 12 determines information transmitted from the gateway instrument 16 and performs a necessary process. When traffic information data around the vehicle is transmitted, for example, the controller 12 favorably allows the display apparatus 17 to display the traffic information (such as the degree of congestion) so as to be overlaid on a map based on the above-described traffic information data.

The storage 13 stores road shape data. The road shape data includes information such as an automatic-operation-dedicated road, an automatic-operation-prioritized road (allowing a mixture of manual operation and automatic operation), a manual-operation-dedicated road, and a road allowing the automatic operation only to a vehicle given the automatic operation accuracy (performance) higher than or equal to a predetermined value. Namely, the automatic operation categories are stored as road characteristics. When the display apparatus 17 displays a map, the map also displays the automatic operation categories of nearby roads.

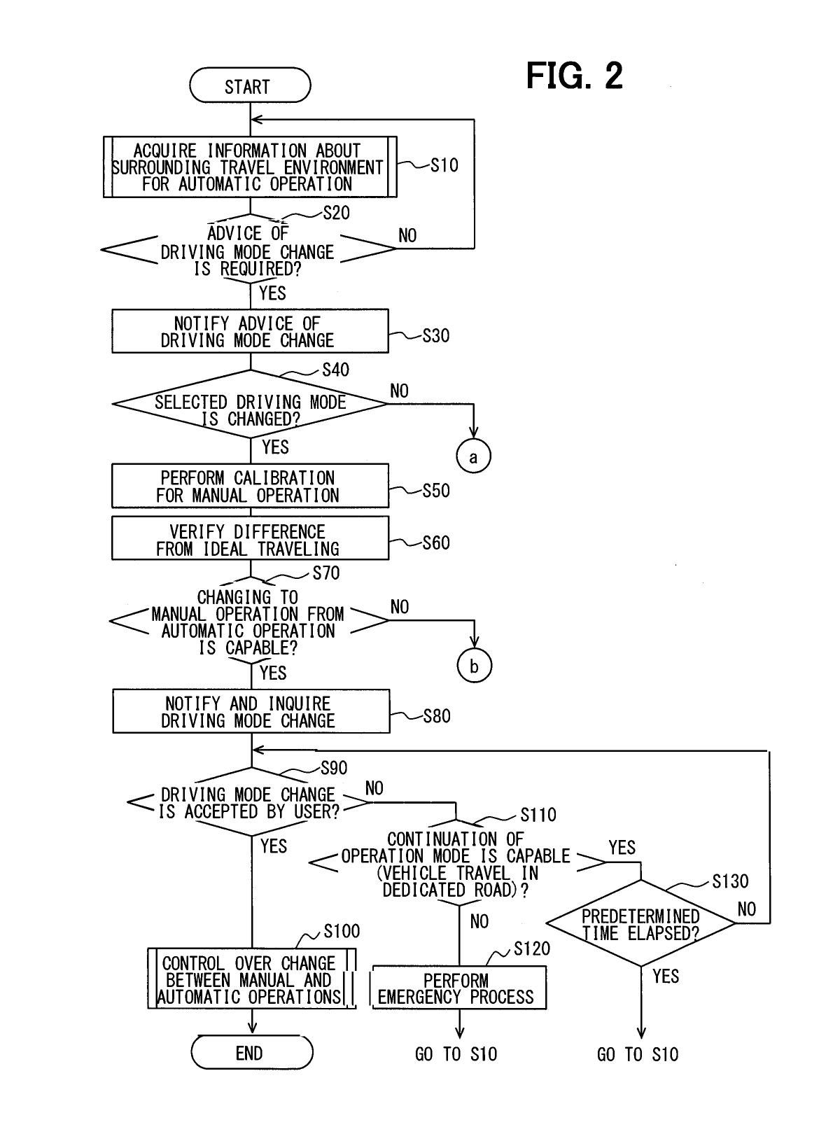

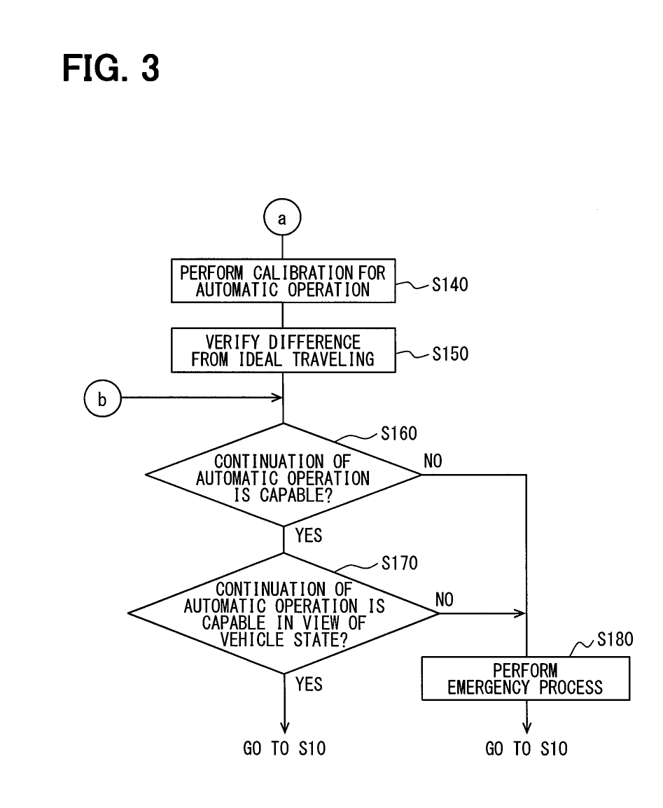

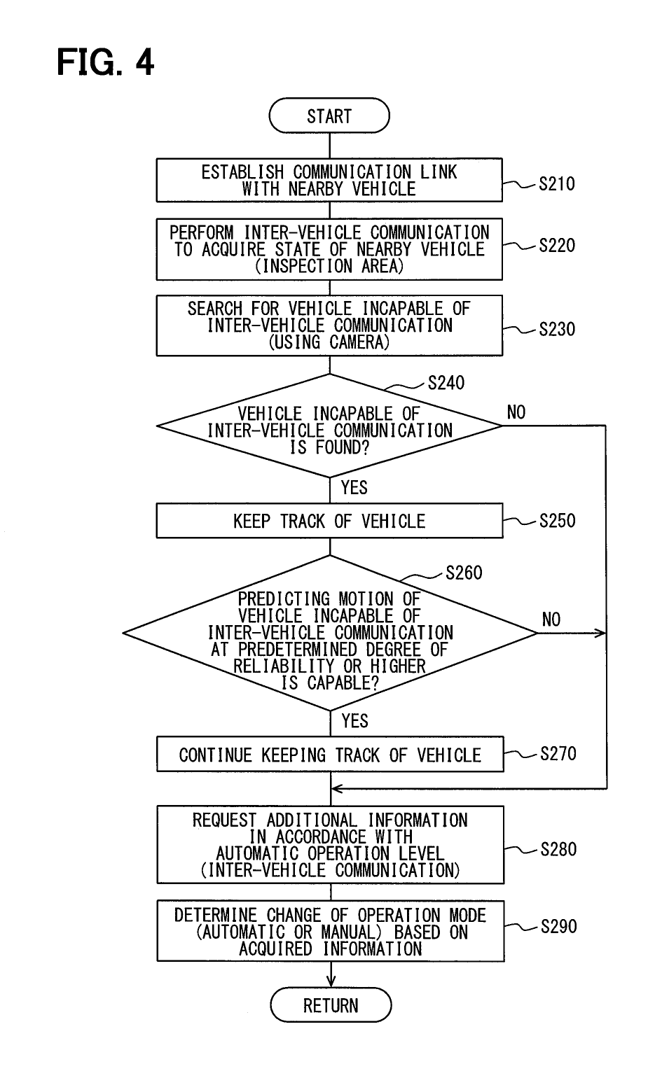

The description below explains operations of the above-described configuration with reference to FIGS. 2 through 8. Flowcharts in FIGS. 2 and 3 illustrate the contents of the main control of the controller 12. In S10 in FIG. 2, the controller 12 acquires information about the surrounding travel environment when the subject vehicle is automatically operated. As will be described later, a sub-control of the controller 12 illustrated by a flowchart in FIG. 4 provides this information acquisition process.

The process then proceeds to S20 and, based on the acquired information about the surrounding travel environment, determines whether it is necessary to advise a change of the driving mode (such as changing the automatic operation to the manual operation). When the driving mode does not need to be changed, the process proceeds to “NO” and returns to S10.

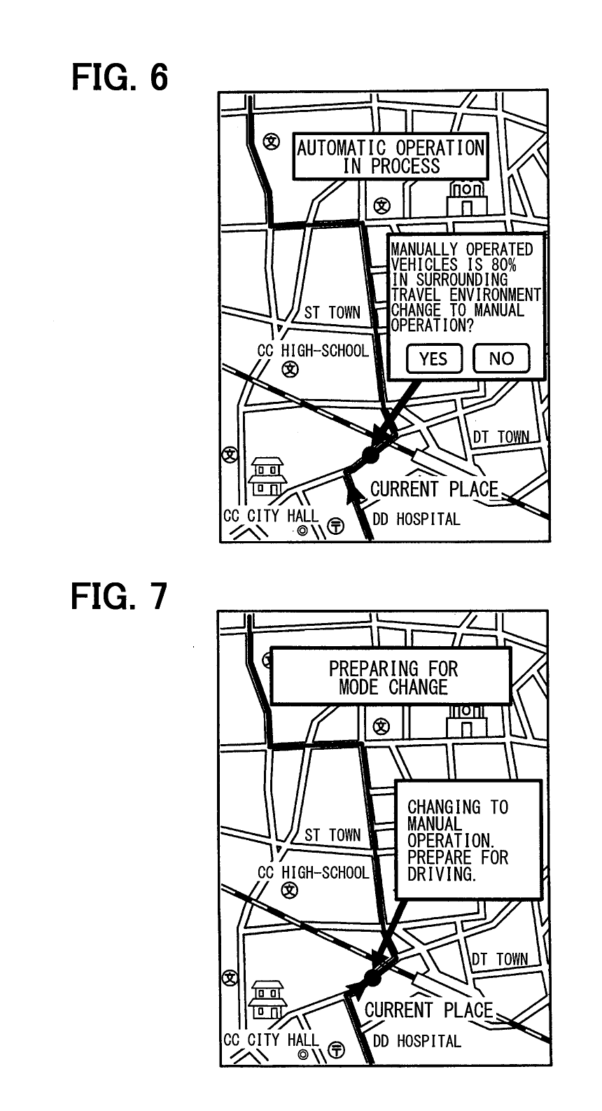

In S20, when the driving mode needs to be changed (YES), the process proceeds to S30 and the controller 12 notifies the user that a change of the driving mode is advised. In this case, as illustrated in FIG. 6, the process is performed to allow the display apparatus 17 to display guidance to change the driving mode, for example. The change guidance may be audibly output.

The process proceeds to S40 and determines whether the driver accepts the driving change in response to the notification of the driving change. When the driver accepts the driving change (YES), the process proceeds to S50 and performs calibration for the manual operation. In this case, the process acquires information about a traveling state (namely, a manual operation history) and a road environment situation and, based on the acquired information, determines whether the driver is capable of the manual operation. Namely, the controller 12 confirms the history of driving in the manual operation by the driver and confirms whether the driver is capable of changing the driving mode. For example, the process confirms whether the driver is good at changing the driving mode according to the history of biological sensing data of the driver (namely, the user) concerning the driving mode change. The process also acknowledges a road environment at the point to change the driving mode from a database in the storage 13 and predictably determines whether the point (such as geography) enables the driver to safely change the driving mode. Favorably, the determination also confirms the past driving ability of the driver.

The controller 12 proceeds to S60 and, based on the manual operation data for the day, determines how much difference is there between the result of the manual operation of the driver and the ideal safe driving. Namely, the process confirms the manual operation ability for the day and determines whether it is possible to change to the manual operation. The controller 12 proceeds to S70 and determines whether it is possible to change the driving mode, based on the results of confirming the driving ability in the past and the driving ability for the day. When it is determined that the automatic operation can be changed to the manual operation (YES), the controller 12 proceeds to S80, notifies the driving mode change from the automatic operation to the manual operation, and inquires the driving mode change.

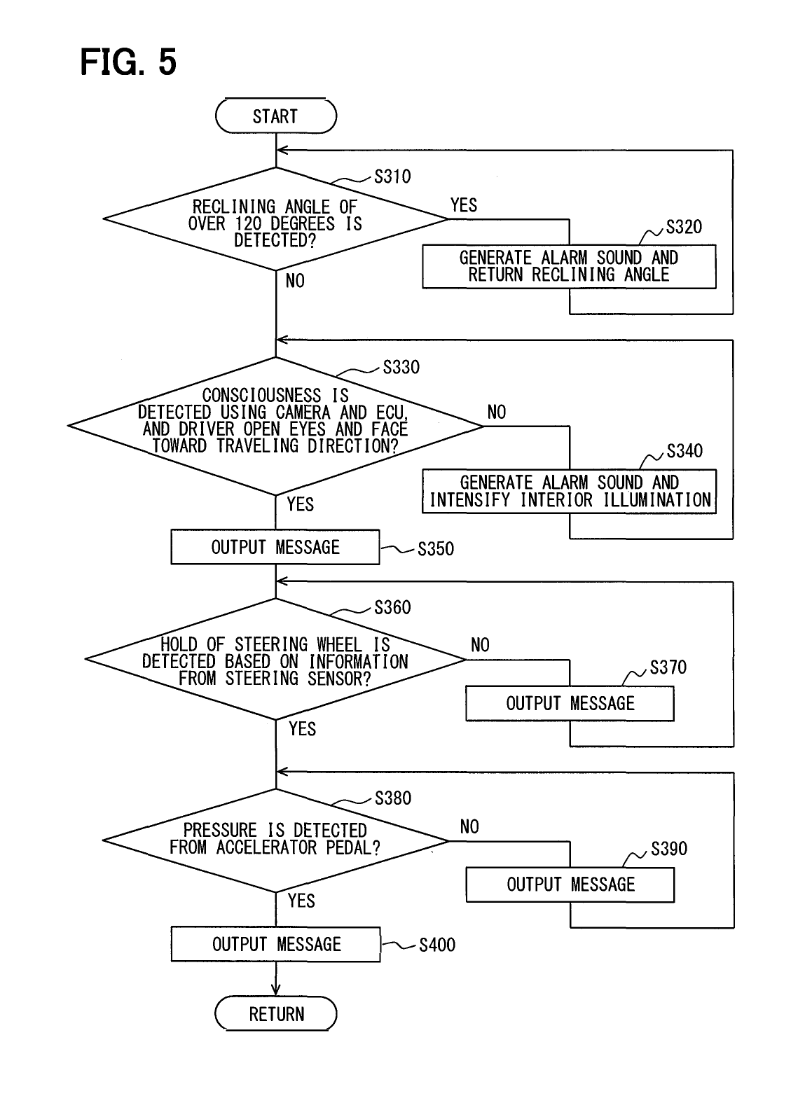

The controller 12 proceeds to S90 and determines whether the driver accepts (approves) the change of the driving mode. When the driver affirms the driving mode change (YES), the controller 12 proceeds to S100 and controls the change between the manual and automatic operation modes. As will be described later, a sub-control of the controller 12 illustrated by a flowchart in FIG. 5 provides this change control. The display apparatus 17 displays a guidance message as illustrated in FIG. 7 during the control over the change between the manual and automatic operation modes. The above-described guidance message may be audibly output. The change control then terminates.

In S90, when the driver returns no response or negates the change of the driving mode (NO), the controller 12 proceeds to S110 and determines whether it is possible to continue the automatic operation mode. When the automatic operation mode is able to continue (YES), the process proceeds to S130 and awaits a response from the driver until a predetermined time elapses. In S130, when the predetermined time elapses (NO), the process returns to S10.

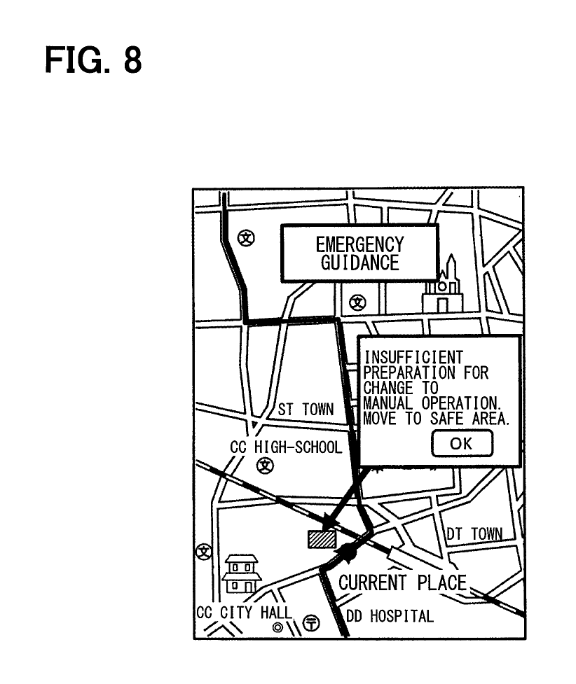

In S110, when the automatic operation mode is unable to continue, namely, the change to the manual operation mode is required (YES), the controller 12 proceeds to S120 and performs an emergency process. In this case, the automatic operation cannot continue and needs to be changed to the manual operation. However, it is determined that the driver cannot change the operation to the manual operation. Therefore, the emergency process is performed, allowing the vehicle to move to a safe position and wait until the situation changes to enable the manual operation. The emergency process, when performed, causes the situation to be notified or an error message to be displayed (such as a display mode illustrated in FIG. 8) for the driver as needed. It is favorable to prepare a plurality of notification methods corresponding to characteristics of the driver so that the driver does not feel uneasy. Control returns to S10 after the emergency process is performed.

In S40, when the driver does not select the driving change (NO), control proceeds to S140 in FIG. 3 to perform calibration for the automatic operation. In this case, the process acquires information about a traveling state (namely, a manual operation history) and a road environment situation and, based on the acquired information, determines whether the automatic operation is available. Namely, the controller 12 confirms the history of driving in the manual operation and confirms whether the automatic operation can continue.

The controller 12 proceeds to S150 and, based on the automatic operation data for the day, determines how much difference is there between the result of the automatic operation and the ideal safe driving. Namely, the process confirms the automatic operation ability for the day and determines whether it is possible to change to the manual operation. The controller 12 proceeds to S160 and determines whether the automatic operation can continue. When it is determined that the automatic operation can continue (YES), the controller 12 proceeds to S170, confirms the vehicle state, and determines whether the automatic operation continues normally. When it is determined that the automatic operation continues normally (YES), the process continues the automatic operation and returns to S10.

In S170, when the automatic operation does not continue normally (NO), the controller 12 proceeds to S180 and performs the emergency process. In this case, the automatic operation cannot continue and needs to be changed to the manual operation. However, the driver does not change the operation to the manual operation. Namely, the driver cannot perform the manual operation. Therefore, the emergency process is performed, allowing the vehicle to move to a safe position and wait until the situation changes to enable the manual operation. The emergency process, when performed, causes the situation to be notified or an error message to be displayed (such as a display mode illustrated in FIG. 8) for the driver as needed. It is favorable to prepare a plurality of notification methods corresponding to characteristics of the driver so that the driver does not feel uneasy. Control returns to S10 after the emergency process is performed.

In S70 in FIG. 2, when it is determined that the automatic operation cannot be changed to the manual operation, the controller 12 proceeds to S160 in FIG. 3 and determines whether the automatic operation can continue. The process in S S160 through S180 is performed as above.

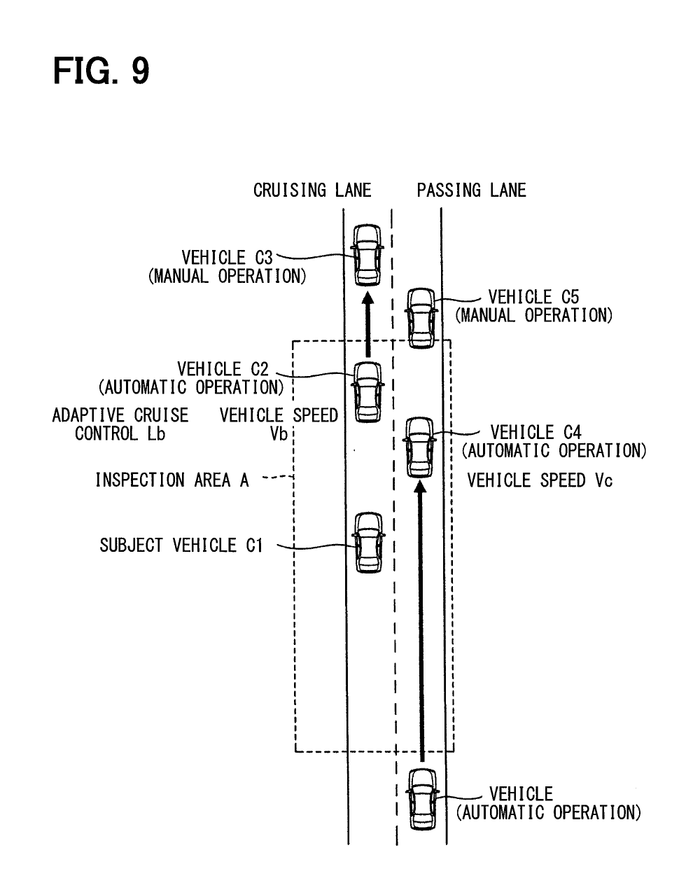

The description below explains control over specific travel operations according to the present embodiment with reference to FIG. 9. As illustrated in FIG. 9, subject vehicle C1 is traveling a cruising lane of an expressway under the automatic operation control. Vehicle C2 ahead of subject vehicle C1 denotes an automatically operated vehicle. Vehicle C2 performs adaptive cruise control over manually operated vehicle C3 traveling ahead. Vehicle C4 travels a passing lane and performs the automatic operation control. Vehicle C4 performs the adaptive cruise control over manually operated vehicle C5 ahead. Subject vehicle C1 has a communication function that performs inter-vehicle communication with vehicles C2 and C4 existing in inspection area A.

If all the vehicles in inspection area A in FIG. 9 have the communication function, subject vehicle C1 can acknowledge the surrounding travel environment, namely, information about which vehicle travels which lane. However, if only some of the vehicles in inspection area A have the communication function, it is necessary to specify a vehicle not having the communication function and monitor the movement of that vehicle. Namely, a vehicle incapable of inter-vehicle communication increases loads on a surrounding monitoring function of the driving assistance device 1. Therefore, recognition of the surrounding travel environment requires detecting a vehicle capable of inter-vehicle communication and a vehicle incapable of the same.

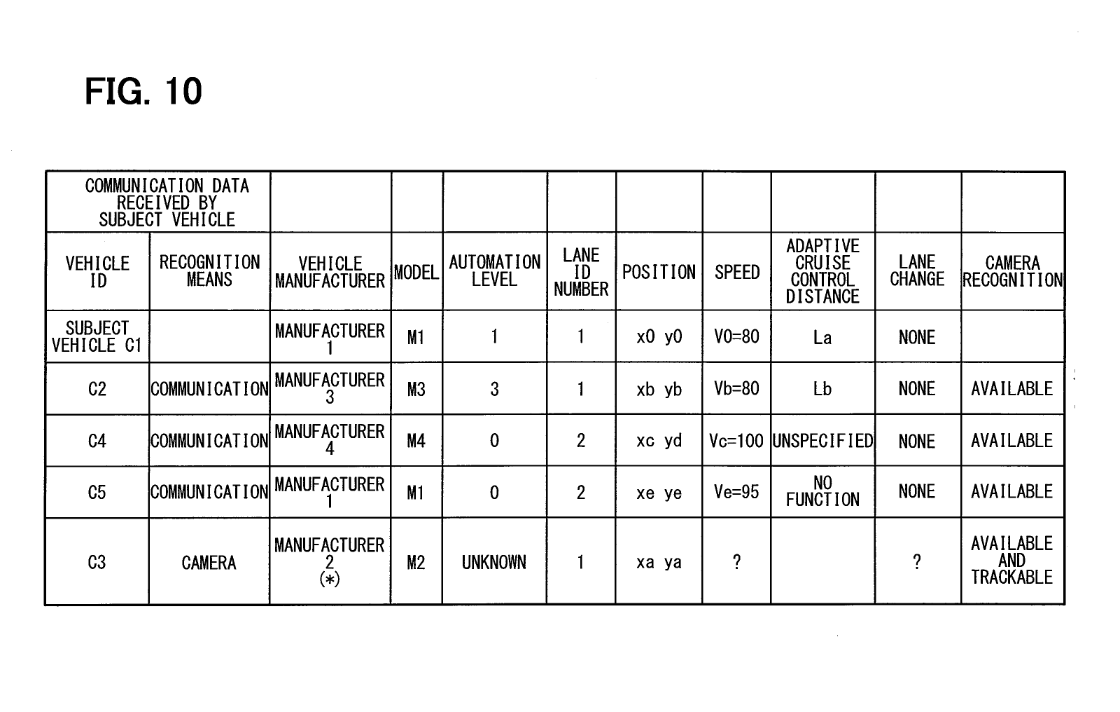

With reference to a flowchart in FIG. 4, the description below explains the control to acquire information about the surrounding travel environment in S10 in FIG. 2. The automatic operation is performed to start a process that acknowledges the surrounding environment. In S210 in FIG. 4, the process establishes a communication link with a nearby vehicle in the inspection area via the communicator 14. The communication link makes it possible to exchange data with a vehicle having an inter-vehicle communication instrument. The process proceeds to S220 and performs the inter-vehicle communication to acquire information about a vehicle state of a nearby vehicle (namely, a vehicle in inspection area A). The acquired information includes data such as vehicle ID, vehicle manufacturer, vehicle model, automation level of the automatic operation, identification number of a lane traveled by the vehicle, travel speed of the vehicle, adaptive cruise control distance under the automatic adaptive cruise control if performed, and situation of the lane change. A diagram in FIG. 10 illustrates the information. In the diagram of FIG. 10, data for the communication corresponding to the recognition means is acquired in S220.

The controller 12 proceeds to S230 and uses the camera 5 to search for a vehicle that failed to exchange the information during the inter-vehicle communication. In this case, the camera 5 detects nearby vehicles and specifies a vehicle that failed in the communication. The process then proceeds to S240 and determines whether there is a vehicle incapable of the inter-vehicle communication. When a vehicle incapable of the inter-vehicle communication is detected (YES), the process proceeds to S250, keeps track of the vehicle incapable of the inter-vehicle communication, and performs a process that confirms (or measures) vehicle movement situations such as positions and motions. This process acquires (or measures) information about movement situations of the vehicle incapable of the inter-vehicle communication. When it is possible to keep track of motions of the vehicle incapable of the inter-vehicle communication, the vehicle is recorded as a trackable vehicle in the storage 13.

The controller 12 proceeds to S260 and determines whether it is possible to predict motions of the vehicle incapable of the inter-vehicle communication at a predetermined degree of reliability or higher. When the prediction is available at a predetermined degree of reliability or higher (YES), the controller 12 proceeds to S270 and continues keeping track of the vehicle incapable of the inter-vehicle communication.

The process then proceeds to S280 and acquires additional information such as data needed to determine a change in the operation mode of the subject vehicle based on the automatic operation level. Namely, the process requests the necessary data from a different vehicle having the inter-vehicle communication function and acquires the necessary data from the vehicle because the communication link is established between both vehicles. The process proceeds to S290 and, based on the acquired information, determines whether the operation mode of the subject vehicle needs to be changed to the manual operation from the automatic operation. The control in FIG. 4 then terminates and the process proceeds to S20 in FIG. 2.

In S240, when there is no vehicle incapable of the inter-vehicle communication (NO), the process proceeds to S280 to perform the above-described process.

In S260, when it is impossible to predict motions of the vehicle incapable of the inter-vehicle communication at a predetermined degree of reliability or higher (NO), the process proceeds to S280 to perform the above-described process.

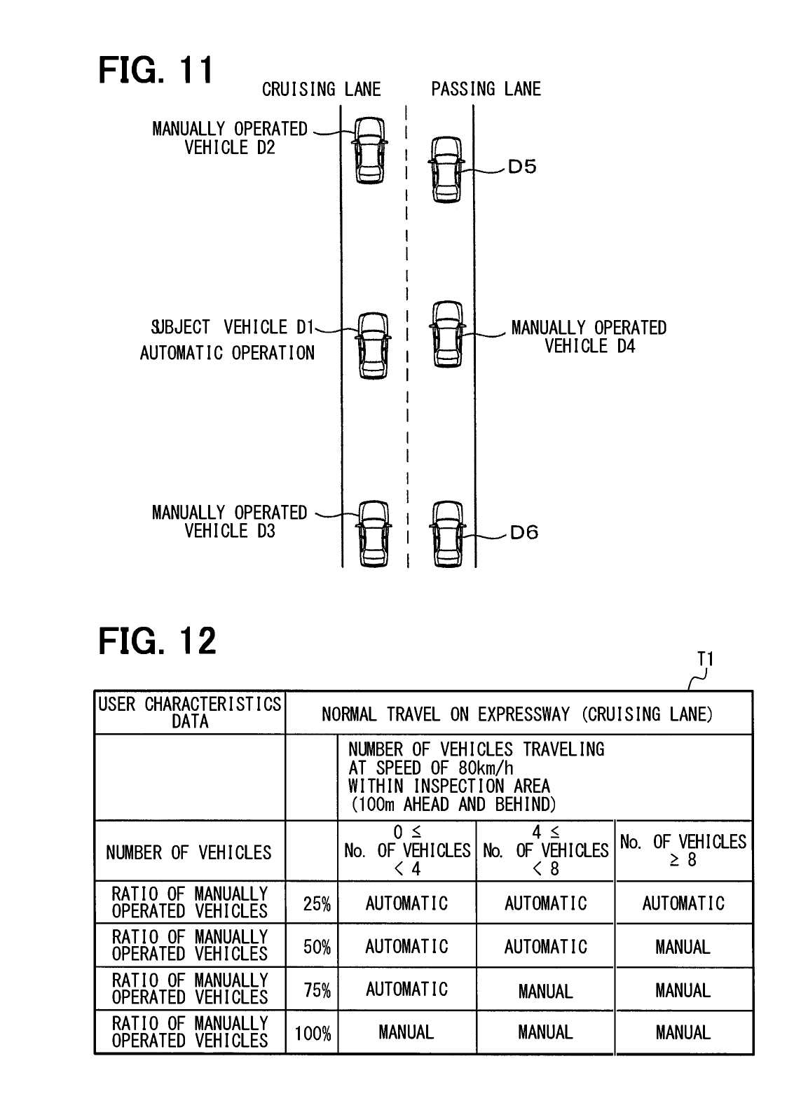

With reference to FIGS. 11 through 20, the description below explains a specific control to determine whether the automatic operation is changed to the manual operation. Diagram T1 in FIG. 12 illustrates determination control examples when subject vehicle D1 travels a cruising lane of an expressway. In diagram T1, each of the cells in the direction of columns (horizontal direction) shows the number of vehicles existing in an inspection area formed 100 [m] ahead of and behind subject vehicle D1. Each of the cells in the direction of rows (vertical direction) shows a ratio of the number of manually operated vehicles to the number of the above-described vehicles. Each of the conditions shows whether to select the manual operation or the automatic operation. A traveling speed of subject vehicle D1 is assumed to be 80 km per hour. FIG. 11 assumes that different vehicles D2, D3, and D4 use the manual operation and different vehicles D5 and D6 use the automatic operation.

A determination control example in diagram T1 determines to select the automatic operation when subject vehicle D1 travels the cruising lane based on the automatic operation and surrounding nearby vehicles are automatically operated. This is because a sudden change in the travel hardly occurs when surrounding nearby vehicles are automatically operated. In contrast, when subject vehicle D1 uses the automatic operation and is surrounded by an increasing number of manually operated vehicles, the possibility of a human error in the operation increases compared to the situation where there are many automatically operated vehicles around. Therefore, it is determined to select the manual operation when manually operated vehicles increase around subject vehicle D1. The difficulty in the automatic operation control increases when the number of vehicles around subject vehicle D1 increases. Therefore, it is determined to select the manual operation compared to the situation where the number of vehicles is small even when the ratio of manually operated vehicles is small.

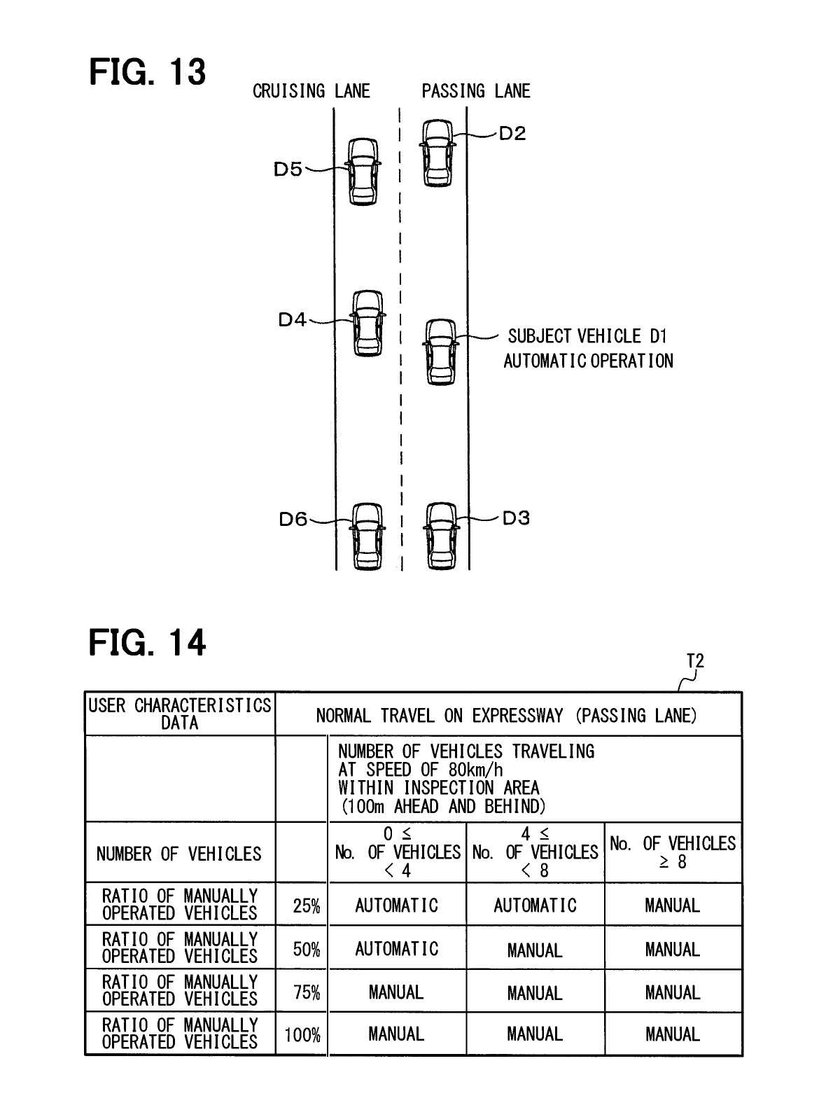

Diagram T2 in FIG. 14 illustrates determination control examples when subject vehicle D1 travels the passing lane of the express as illustrated in FIG. 13. In diagram T2, each of the cells in the direction of columns shows the number of vehicles existing in inspection area A formed 100 [m] ahead of and behind subject vehicle D1. Each of the cells in the direction of rows shows a ratio of the number of manually operated vehicles to the number of the above-described vehicles. Each of the conditions shows whether to select the manual operation or the automatic operation. A traveling speed of subject vehicle D1 is assumed to be 80 km per hour. FIG. 13 assumes that different vehicles D2, D3, and D4 use the manual operation and different vehicles D5 and D6 use the automatic operation.

A determination control example in diagram T2 determines to select the automatic operation when subject vehicle D1 travels the passing lane based on the automatic operation and subject vehicle D1 is surrounded by automatically operated vehicles. This is because a sudden change in the travel hardly occurs when subject vehicle D1 is surrounded by automatically operated vehicles even though the passing lane causes vehicle movement such as lane changing more frequently than the cruising lane and increases the possibility of danger. However, it is determined to select the manual operation when subject vehicle D1 travels the passing lane when subject vehicle D1 is surrounded by manually operated vehicles. The reason is to deal with a sudden movement of a different vehicle as a manually operated vehicle even when the ratio of manually operated vehicles is small. The determination condition to select the automatic operation for subject vehicle D1 traveling the cruising lane may replace the determination condition to select the manual operation for subject vehicle D1 traveling the passing lane.

The determination controls in diagrams T1 and T2 are performed when the subject vehicle or the different vehicle causes a small variation in the vehicle speed. The control is performed to change the automatic operation to the manual operation when a variation in the vehicle speed is large. It is favorable to be capable of changing the manual operation to the automatic operation in diagrams T1 and T2 when a response (such as a level) of the automatic operation is improved.

It is also favorable to be capable of changing determination conditions (such as diagrams T1 and T2) as needed in accordance with the degree of reliability of a driver (or a user) of the subject vehicle concerning the automatic operation of the subject vehicle and different vehicles and the degree of reliability of the driver of the subject vehicle concerning manually operated vehicles. It is favorable to be capable of widening the range of determination to select the automatic operation when the driver is determined to improve the accuracy of controlling the automatic operation. The driver or an information center may be able to customize the determination diagrams T1 and T2. The center server 23 may provide the degree of control reliability on different vehicles as automatically operated vehicles.

The initially introduced automatic operation is not supposed to provide high accuracy. There may be a vehicle that causes the control accuracy of the automatic operation to be lower than the manual operation. In such a case, it is favorable to be able to handle a vehicle having low control accuracy over the automatic operation similar to a manually operated vehicle. In terms of control accuracy concerning the automatic operation, the inter-vehicle communication may be used to acquire the manufacturer or the model of an adjacent vehicle and information about an automatic control instrument mounted on the adjacent vehicle and acquire the automatic operation control accuracy of the adjacent vehicle from a server, for example.

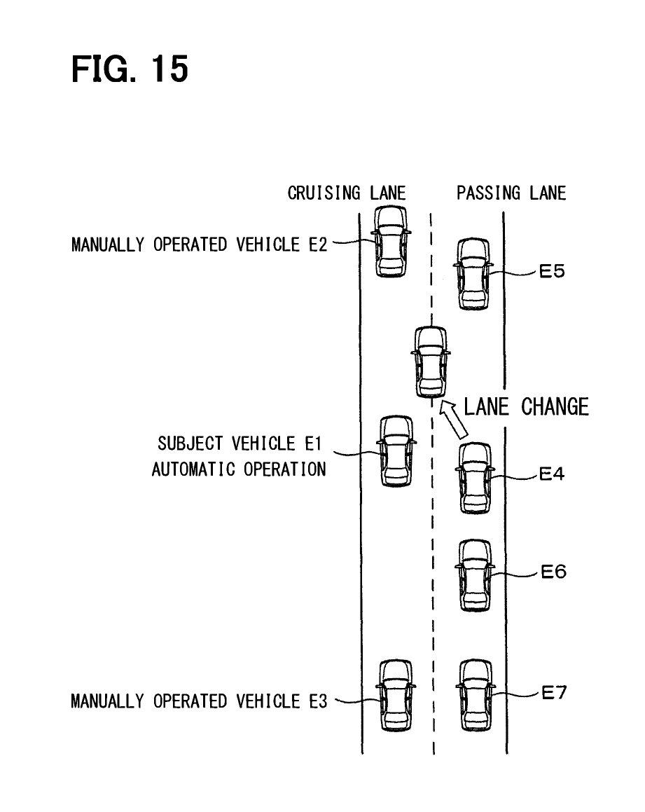

When a subject vehicle in the automatic operation travels a cruising lane and decelerates to approach a congested area, with reference to FIGS. 15 through 17, the description below explains control examples of determining whether to select the automatic operation or the manual operation in accordance with the frequency of nearby vehicles to change lanes. In FIG. 15, subject vehicle E1 is supposed to use the automatic operation. Different vehicles E2, E3, and E4 are supposed to use the manual operation. Different vehicle E4 is supposed to change the lane. Different vehicles E5, E6, and E7 are supposed to use the automatic operation.

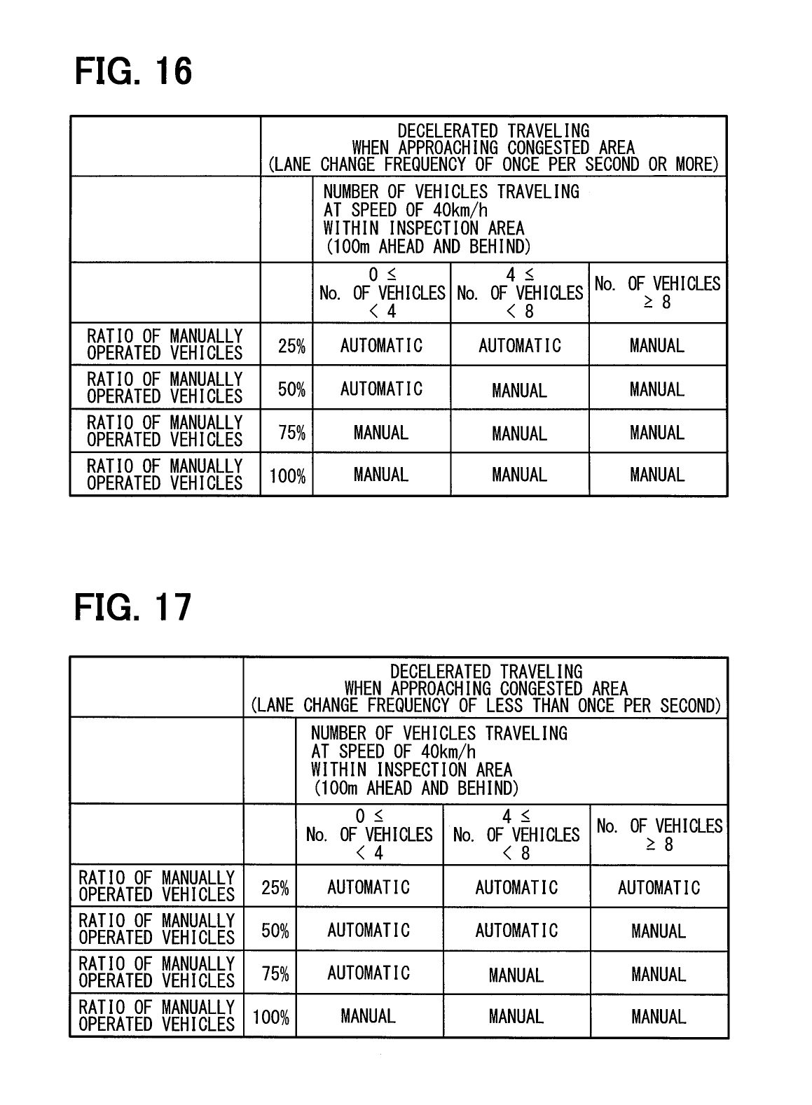

In this control example, the automatic operation is safe when different vehicles around subject vehicle El less frequently change the lane. If surrounding different vehicles frequently change the lane, it is difficult to observe (or detect) the nearby vehicles, making the automatic operation difficult. In this case, therefore, it is determined to select the manual operation. Determination diagrams in FIGS. 16 and 17 are generated based on this determination control. The diagram in FIG. 16 shows the lane change frequency of once a second or more. The diagram in FIG. 17 shows the lane change frequency of less than once a second.

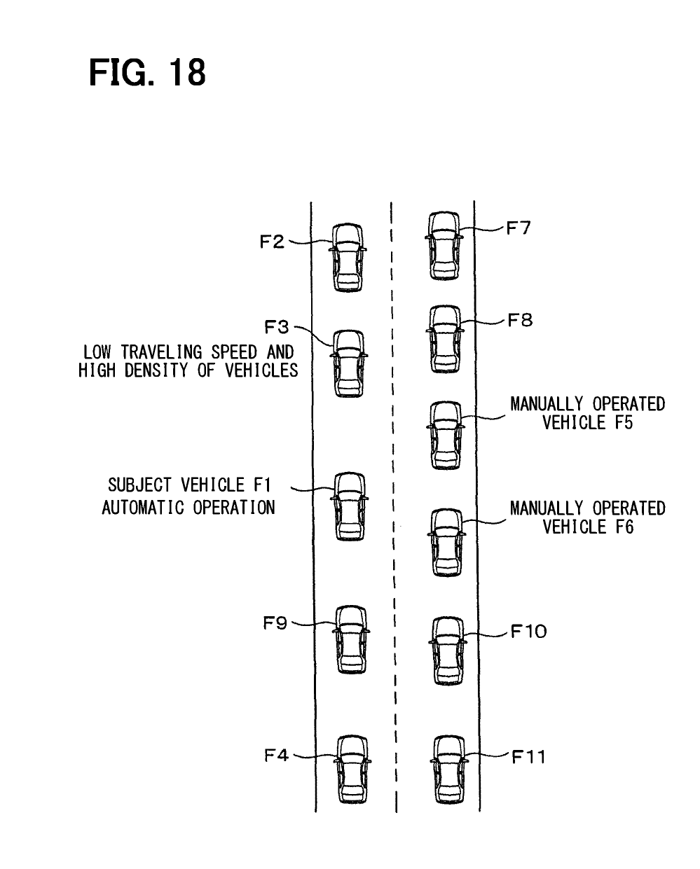

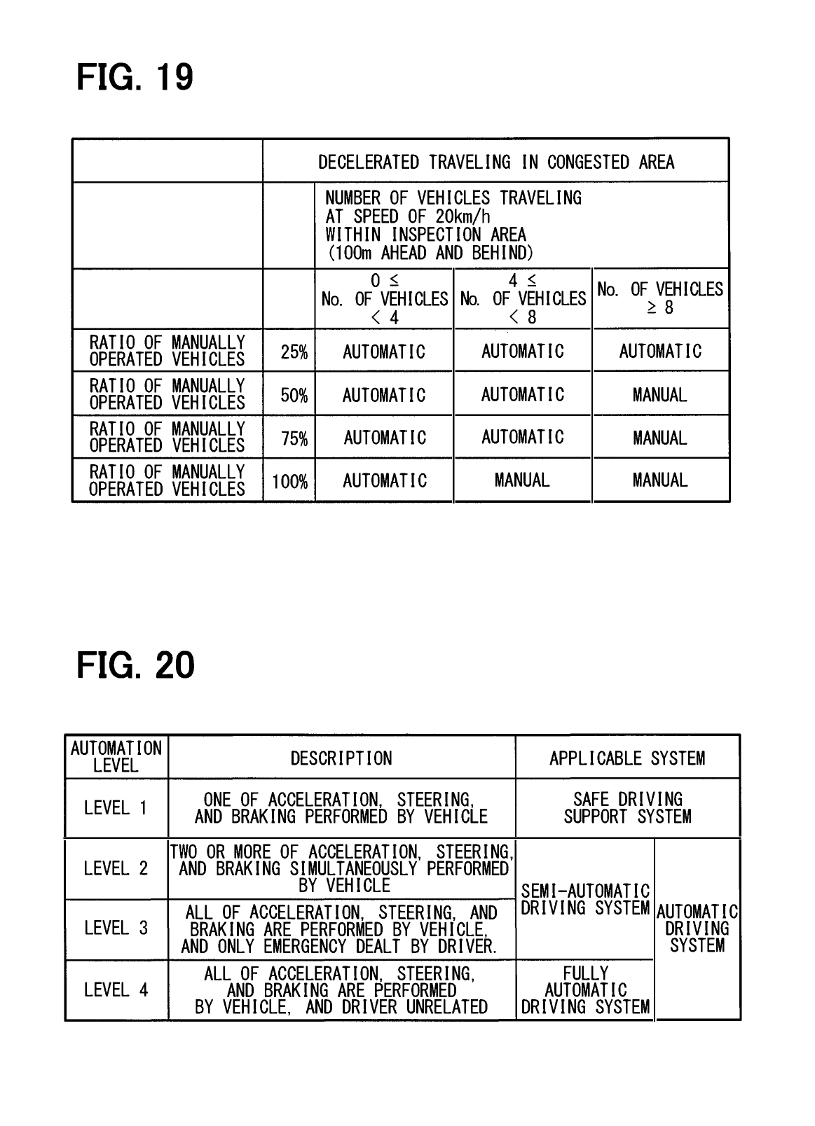

With reference to FIGS. 18 and 19, the description below explains control examples of determining whether to select the automatic operation or the manual operation when the subject vehicle in the process of the automatic operation travels a congested road at a low speed. In FIG. 18, subject vehicle F1 in the process of the automatic operation is supposed to travel a congested road at a low speed. Different vehicles F2, F3, F4, F5, and F6 are supposed to be manually operated. Different vehicles F7, F8, F9, F10, and F11 are supposed to be automatically operated.

This control example determines to select the automatic operation as operation mode because the travel during congestion decreases a travel speed of the vehicle, disables a sudden movement of the vehicle, and therefore makes the control over the automatic operation easy. However, it is determined to select the manual operation when a manually operated different vehicle is detected to frequently change the lane, because the automatic operation is unlikely to fully function. When the number of nearby vehicles is small, the automatic operation control is used because it is easy to observe a nearby vehicle moving at a low speed. It is determined to select the manual operation when the number of nearby vehicles increases to increase the ratio of manually operated vehicles. This is because a manually operated vehicle is more likely to unexpectedly change the lane or cause braking. A determination diagram in FIG. 19 is generated based on this determination control. In the diagram in FIG. 19, inspection area A is supposed to exist 100 [m] ahead of and behind the vehicle. The vehicle speed is supposed to be 20 km/h.

The above-described determination is just an example. It is favorable to be capable of changing, as needed, a condition of determining whether a driver (or a user) selects the manual operation or the automatic operation. It is favorable to provide a notification that matches the sensibility of a driver when the operation mode is changed.

A diagram in FIG. 20 defines automation levels of the automatic operation. The diagram defines four levels from level 1 to level 4 as automation levels of the automatic operation, providing the above-described determination condition (the condition of determining whether to select the automatic operation or the manual operation) corresponding to each level.

With reference to a flowchart in FIG. 5, the description below explains the control over the change between the manual and automatic operation modes in S100 in FIG. 2. In S310, the controller 12 determines whether the driver's seat reclines at an angle of over 120 degrees. When the driver's seat reclines at an angle of over 120 degrees (YES), the process proceeds to S320, notifies the driver by sounding an alarm, and performs a control to return the reclining angle to 120 degrees. The process then returns to S310.

In S310, when the driver's seat does not recline at an angle of over 120 degrees (NO), the controller 12 proceeds to S330 and determines whether the driver opens the eyes and faces toward the traveling direction, based on the detection information from the drivers' action detector 2 and the drivers' biological information detector 3. When the driver does not open the eyes or face towards the traveling direction (NO), the process proceeds to S340, notifies the driver by sounding an alarm, and intensifies an interior illumination so that the driver is awakened, opens the eyes, and faces toward the traveling direction. The process then returns to S330.

In S330, when the driver opens the eyes and faces toward the traveling direction (YES), the process proceeds to S350 and audibly outputs a message such as “The automatic operation is difficult. Prepare for the driving.” and displays the message on the display apparatus 17. The process proceeds to S360 and determines whether the driver holds the steering wheel, based on information from a steering sensor. When the driver does not hold the steering wheel (NO), the process proceeds to S370 and audibly outputs a message such as “Hold the steering wheel.” and displays the message on the display apparatus 17. The process then returns to S360.

In S360, when the driver holds the steering wheel (YES), the process proceeds to S380 and determines whether the pressure is detected from an accelerator pedal, that is, the driver presses the accelerator pedal. When the driver does not press the accelerator pedal (NO), the process proceeds to S390, audibly outputs a message such as “Step the accelerator pedal.” and displays the message on the display apparatus 17. The process then returns to S380.

In S380, when the driver presses the accelerator pedal (YES), the process proceeds to S400, audibly outputs a message such as “All systems go. Press the switch to start the manual operation.” and displays the message on the display apparatus 17. The process terminates the control over the change between the manual and automatic operation modes and returns to the control in FIG. 2.

The present embodiment according to the above-described configuration provides a traveling prediction unit 12 that acquires data such as traveling situation, travel speed, inter-vehicle distance, acceleration control, braking control, and steering control concerning a nearby vehicle having the communication function. The traveling prediction unit 12 detects a nearby vehicle having no communication function and detects a traveling situation of the vehicle having no communication function. The traveling prediction unit 12 predicts a traveling state of the nearby vehicle based on traveling situation data acquired by the communication function and traveling situation data acquired by the detection. The traveling prediction unit 12 notifies a prediction result to the user. This configuration can provide various effects such as a capability of detecting whether the nearby vehicle is automatically operated or manually operated.

According to the present embodiment, the traveling prediction unit 12 advises the user to change the driving mode when it is determined that the prediction result does not provide sufficient prediction accuracy. Therefore, it is possible to easily change the automatic operation to the manual operation.

The present embodiment provides the user information acquisition unit, the ability detector, and the ability-to-deal-with-driving determination unit. The user information acquisition unit acquires physical information about a driver. The ability detector detects the ability of the driver to manually operate the subject vehicle based on the physical information about the driver. The ability-to-deal-with-driving determination unit determines, based on the detected driver ability, whether the driver can deal with the traveling state of a nearby vehicle predicted by the traveling prediction unit. It is possible to prevent the driving mode from changing from the automatic operation to the manual operation when the driver is incapable of the manual operation.

The present embodiment provides the manual changeover restrictor that restricts the change to the manual operation until the driver is capable of dealing when the ability-to-deal-with-driving determination unit determines that the driver is incapable of dealing. Therefore, it is possible to prevent the driving mode from changing to the manual operation from the automatic operation when the driver is incapable of dealing. In such a case, the present embodiment provides control to move the vehicle to a safe place to stop.

The present embodiment provides the automatic operation determination unit and the automatic changeover restrictor. The automatic operation determination unit determines whether the traveling state of the nearby vehicle predicted by the traveling prediction unit is inappropriate for the automatic operation. The automatic changeover restrictor restricts the change to the automatic operation mode until the traveling state changes to be appropriate for the automatic operation. It is possible to prevent the driving mode from changing to the automatic operation from the manual operation when the traveling state is inappropriate for the automatic operation.

The present embodiment can change the driving mode of a vehicle capable of the automatic operation in accordance with the traveling state of a nearby vehicle, the traveling state of the subject vehicle, and states of the driver. It is possible to relieve the driver from uneasiness during a change between the automatic operation and the manual operation.

Although the present disclosure has been described in accordance with the examples, it is understood that the disclosure is not limited to such examples or structures. The present disclosure covers various modification examples and equivalent arrangements. In addition, while the various elements are shown in various combinations and configurations, which are exemplary, other combinations and configurations, including more, less or only a single element, are also within the spirit and scope of the present disclosure.

The flowcharts or the processing depicted in the flowcharts according to the present disclosure include a plurality of sections (alternatively referred to as steps) each indicated as S10 or the like. Some of the sections may be further divided into a plurality of subsections or may be appropriately combined to configure a single section. Each of these sections may also be referred to as a circuit, a device, a module, or means.

Each of the plurality of sections or some of the sections combined to each other can be embodied as (i) a software section combined with a hardware unit (e.g., a computer) or (ii) a hardware section (e.g., an integrated circuit or a wiring logic circuit) including or excluding a function of a relevant device. The hardware section may still alternatively be installed in a microcomputer.

1. A driving assistance device comprising:
a vehicle data acquisition unit configured to acquire data on a traveling situation, a travel speed, an inter-vehicle distance, an acceleration control, a braking control, and a steering control related to a nearby vehicle having a communication function;
a detector configured to detect a nearby vehicle having no communication function;
a traveling situation detector configured to detect a traveling situation of the nearby vehicle having no communication function; and
a traveling prediction unit configured to predict a traveling state of the nearby vehicle having the communication function based on traveling situation data acquired by the vehicle data acquisition unit, and predict a traveling state of the nearby vehicle having no communication function based on traveling situation data acquired by the traveling situation detector,
wherein:
the traveling prediction unit includes a notification unit that notifies a prediction result to a user; and
the traveling prediction unit advises the user to change a driving mode when the traveling prediction unit determines that prediction accuracy of the prediction result is insufficient,
the driving assistance device further comprising
a ready determination unit configured to determine whether the user is ready for changing to a manual operation when changing of the driving mode from an automatic operation to the manual operation is approved by the user.

2. The driving assistance device according to claim 1, wherein
the ready determination unit determines at least one of whether the driver reclines a seat at an appropriate degree, whether the driver opens eyes and faces toward a traveling direction, whether the driver is holding a steering wheel, and whether the driver is stepping an accelerator pedal.

3. The driving assistance device according to claim 1, further comprising:
an automatic operation determination unit configured to determine whether the traveling state of the nearby vehicle predicted by the traveling prediction unit is inappropriate for an automatic operation; and
an automatic changeover restrictor configured to restrict a change to the automatic operation until the traveling state alters to be appropriate for the automatic operation.

4. A driving assistance device comprising:
a vehicle data acquisition unit configured to acquire data on a traveling situation, a travel speed, an inter-vehicle distance, an acceleration control, a braking control, and a steering control related to a nearby vehicle having a communication function;
a detector configured to detect a nearby vehicle having no communication function;
a traveling situation detector configured to detect a traveling situation of the nearby vehicle having no communication function;
a traveling prediction unit configured to predict a traveling state of the nearby vehicle having the communication function based on traveling situation data acquired by the vehicle data acquisition unit, and predict a traveling state of the nearby vehicle having no communication function based on traveling situation data acquired by the traveling situation detector;
a user information acquisition unit configured to acquire physical information of a driver;
an ability detector configured to detect an ability of the driver to perform a manual operation of a subject vehicle based on the physical information of the driver; and
an ability-to-deal-with-driving determination unit configured to determine, based on the detected ability of the driver, whether the ability of the driver to perform the manual operation of the subject vehicle is sufficient to deal with the traveling state of the nearby vehicle predicted by the traveling prediction unit when a change to the manual operation is selected by the driver.

5. The driving assistance device according to claim 3, further comprising
a manual changeover restrictor configured to restrict the change to the manual operation until the traveling state alters to allow the driver to deal with when the ability-to-deal-with-driving determination unit determines that the traveling state cannot be dealt with by the driver.

6. The driving assistance device according to claim 3, further comprising:
an automatic operation determination unit configured to determine whether the traveling state of the nearby vehicle predicted by the traveling prediction unit is inappropriate for an automatic operation; and
an automatic changeover restrictor configured to restrict a change to the automatic operation until the traveling state alters to be appropriate for the automatic operation.

7. A driving assistance device comprising:
a processor configured to:
acquire data on a traveling situation, a travel speed, an inter-vehicle distance, an acceleration control, a braking control, and a steering control related to a nearby vehicle having a communication function;
detect a nearby vehicle having no communication function;
detect a traveling situation of the nearby vehicle having no communication function;
predict a traveling state of the nearby vehicle having the communication function based on traveling situation data acquired by the vehicle data acquisition unit, and predict a traveling state of the nearby vehicle having no communication function based on traveling situation data acquired by the traveling situation detector,
notify a prediction result to a user;
advise the user to change a driving mode when the traveling prediction unit determines that prediction accuracy of the prediction result is insufficient; and
determine whether the user is ready for changing to a manual operation when changing of the driving mode from an automatic operation to the manual operation is approved by the user.
